(19) United States
(12) Patent Application Publication
(10) Pub. No.: US 2011/0305628 A1
(43) Pub. Date: Dec. 15, 2011

(54) PROCESS FOR PRODUCING HYDROGEN AT LOW TEMPERATURE

(76) Inventors: Yuh-Jeen HUANG, Hsinchu (TW); Ke-Lun Ng., Hsinchu (TW)

(21) Appl. No.: 12/871,280

(22) Filed: Aug. 30, 2010

(30) Foreign Application Priority Data
Jun. 15, 2010 (TW) 099119430

(51) Int. Cl. C01B 3/06

(52) U.S. Cl. 423/657

(57) ABSTRACT

An oxidative steam reforming of methanol (OSRM) process at low temperature includes providing a gas mixture comprising methanol, steam and oxygen and conducting the gas mixture to flow through an AuCu/ZnO-based catalyst for undergoing OSRM process to generate hydrogen, wherein an initiation temperature of OSRM is less than 175° C. The AuCu/ZnO catalyst of the present invention may lower the initiation temperature of the OSRM process and remains to have good catalytic efficiency without undergoing pre-reduction. A steam reforming of methanol (SRM) process is also herein provided.

### BACKGROUND OF THE INVENTION

1. Field of the Invention

The present invention relates to a process for producing hydrogen at low temperature, more particularly to an OSRM process and an SRM process utilizing an AuCu/ZnO catalyst.

2. Description of the Prior Art

Fuel cells which are capable of converting chemical energy of the fuel into electricity and also satisfy the requirement of environmental protection are currently being developed. Amongst fuel cells under development, PEMFC (proton exchange membrane fuel cell) is preeminent because it can be operated at a low temperature. However, PEMFCs have disadvantages in storage and transportation of hydrogen. To overcome such disadvantages, hydrocarbon molecules are used as the external primary fuel in PEMFCs and converted into hydrogen rich gas (HRG) on site. HRG is a gas mixture with high hydrogen content and one of environmentally friendly fuels applied in fuel cells.

Among studies of hydrocarbon molecule conversion, production of HRG from reforming of methanol has been widely studied because it is highly chemically active, abundant in product, and low cost. Many methanol reforming processes have been developed and published in literatures, for example, (1) steam reforming of methanol (SRM) and (2) partial oxidation of methanol (POM), which may be expressed by the following chemical formulas.

CH₃OH+H₂O→3H₂+CO₂ ΔH=49 kJ mol⁻¹ (1)

CH₃OH+½O₂→2H₂+CO₂ ΔH=−192 kJ mol⁻¹ (2)

Reaction SRM has a high hydrogen yield (number of hydrogen molecule produced from each consumed methanol molecule) of R_{H2}=3.0. However, there is a relative large amount of CO (>1%), which is notorious for poisoning Pt catalyst, deactivating the catalyst and damaging the performance of the PEMFC. In addition, SRM is an endothermic reaction which is not theoretically favored at low temperatures. According to Le Chatelier's Principle, SRM becomes efficient at high temperatures.

Comparatively, exothermic POM is favored at lower temperatures and produces HRG. However, in comparison to theoretic R_{H2}=3.0 in SRM process, a relatively lower hydrogen yield of theoretic R_{H2}=2.0 is produced.

A more advanced process is called “oxidative steam reforming of methanol” (OSRM). OSRM process uses a mixture of water vapor and oxygen as oxidant. In other words, it is a combination of reactions (1) and (2) in an optimized ratio, and a reaction with theoretically negligible reaction heat may be provided at ratio 3.9/1. With a proper ratio of reactions (1) and (2), a desirably high R_{H2} (about 2.75) may be achieved by adding steam on one hand, and the reaction temperature can be decreased due to the presence of oxygen in the OSRM reaction on the other hand.

Catalysts containing Cu or Pd reported in literature require reaction temperature of 250° C. or higher in OSRM process; therefore, fuel reformers need to undergo pre-heating and start-up steps and result in prolonged initiation time and reduced PEMFC practicality. Therefore, if the initiation temperature of OSRM process can be lowered, the initiation time for devices, such as PEMFC, electric car and other electronic devices, may be decreased, and energy loss and cost may also be lowered. Furthermore, the lowering in initiation temperature may increase the stability and life expectancy of the catalysts.

To sum up, the SRM process and OSRM process have advantages in higher R_{H2} in comparison to POM process; therefore, it is now a current goal to lower the reaction temperature of the SRM process and OSRM process and lower the CO content of the SRM process so as to obtain efficient SRM process and OSRM process. In addition, the initiation temperature of SRM process and OSRM process needs to be lowered so as to be applied in PEMFC (80-180° C.).

Catalysts of various compositions may be prepared from metals such as copper, zinc, cerium, zirconium, aluminum and so on with various preparation methods and used for catalyzing methanol reforming process for hydrogen production. Among these catalysts, Cu/ZnO catalyst has advantages in low cost, high reactivity, simple preparation and so on, but large quantity of CO byproduct has constrained the application of the Cu/ZnO catalyst.

Furthermore, Au particle, which has been applied as catalyst, may be used in hydrogen production process and is capable of selectively oxidizing CO. Therefore, the Au nanoparticles added in the catalyst is expected to increase the selectivity and specificity of reaction process.

The Cu/ZnO catalyst containing Au nanoparticles disclosed in Taiwan patent No. I315999 belonging to Chang et al. was prepared with co-precipitation method and aimed at developing a hydrogen production process with a partial oxidation reaction of methanol for decreasing the CO content so as to increase the hydrogen purity in POM process for hydrogen production.

The Au/ZnO catalyst disclosed in U.S. Pat. No. 7,459,000 belonging to Yeh et al. may catalyze OSRM process at relatively low reaction temperature T_{R} (=150° C.) to generate HRG with low S_{co} by passing the mixed vapor of the aqueous methanol and oxygen through a catalyst comprising gold particles supported on zinc oxide. However, the utilized Au/ZnO catalyst needs pre-reduction with hydrogen at high temperature and has limited application in PEMFC.

To sum up, it is now a current goal to develop a catalyst that may overcome the difficulty to reduce the relatively higher reaction temperature of OSRM process and SRM process without catalyst pre-reduction so as to be applied in PEMFC.

### SUMMARY OF THE INVENTION

The present invention is directed to a novel OSRM process and an SRM process with reduced initiation temperature and yet good catalytic efficiency without undergoing pre-reduction.

According to one embodiment, an oxidative steam reforming of methanol process at low temperature comprises providing a gas mixture including methanol, steam and oxygen; and conducting the gas mixture to flow through an AuCu/ZnO-based catalyst for undergoing OSRM process to generate hydrogen, wherein an initiation temperature of OSRM is less than 175° C.

According to another embodiment, a steam reforming of methanol process at low temperature comprises providing a gas mixture including methanol and steam; and conducting the gas mixture to flow through an AuCu/ZnO-based catalyst for undergoing SRM process to generate hydrogen.

Other advantages of the present invention will become apparent from the following descriptions taken in conjunction with the accompanying drawings wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed descriptions, when taken in conjunction with the accompanying drawings, wherein:

FIG. 1 is a schematic diagram illustrating an OSRM system for hydrogen production according to one embodiment of the present invention; and

FIG. 2 is a schematic diagram illustrating a SRM system for hydrogen production according to one embodiment of the present invention.

### DESCRIPTION OF THE PREFERRED EMBODIMENT

The present invention adopts AuCu/ZnO catalyst for catalyzing an OSRM (oxidative steam reforming of methanol) process and an SRM (steam reforming of methanol) process to produce hydrogen rich gas. The catalyst of the present invention may effectively lower the initiation temperature of OSRM process and provide the OSRM process with high C_{MeOH} (methanol conversion rate) and low S_{CO} (CO selectivity). In addition, the AuCu/ZnO catalyst is also very efficient in catalyzing the SRM process.

Preparation of Catalyst In one embodiment, a mixture containing 0.5 M copper nitrate and zinc nitrate was added into 500 ml, 70° C. agitated ultrapure water with ultrasound sonication. The solution was then maintained at pH 7 with 2M Na₂CO₃ solution and aging to pH8 after titration completed. The precipitate was obtained by drying the solution and then added into 500 ml H₂O. The solution was then heated to 70° C. with vigorous agitation, added with 0.01M AuCl₄ in dips and maintained at pH 7 with 2M Na₂CO₃. The solution was further aged for 1 hour after completion of AuCl₄ titration and retained at pH7 with 10% HCl, underwent vacuum suction along with 4 L ultrapure water washing. The precipitate was then dried for 12 hours at 105° C., milled, and calcined at 30 ml/min air flow and a temperature of 400° C. for 2 hours to obtain Au₃Cu₃₀/ZnO catalyst.

The Au_{0.8}Cu₃₀/ZnO, Au_{4.3}Cu₃₀/ZnO catalyst, and Cu₃₀/ZnO, Au_{2.4}/ZnO catalyst for comparison purpose may be obtained and prepared from similar steps.

OSRM process: 4CH₃OH_{(g)}+½O_{2(g)}+3H₂O_{(g)}→11H₂+4CO₂

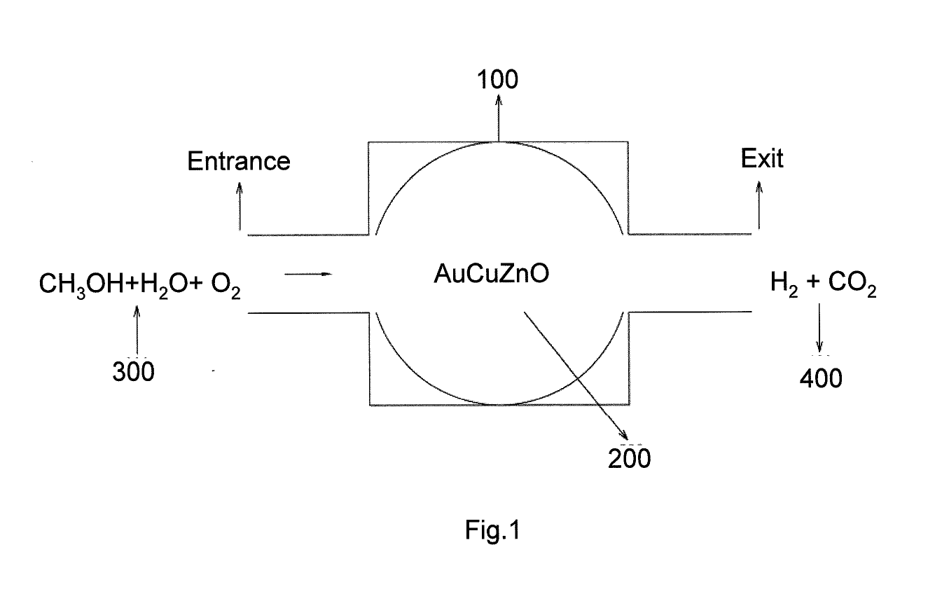

FIG. 1 is a schematic diagram illustrating an OSRM system for hydrogen production according to one embodiment of the present invention. In a fixed bed reactor or a thermally-insulated reactor 100, a 100 mg AuCu/ZnO catalyst sample is placed in a quartz tube with 4 mm inner diameter and is immobilized with silica wool. With regard to reacting gases, an aqueous methanol at a flow rate controlled by a liquid pump is evaporated with a pre-heater. Each flow rate of oxygen and carrier gas (e.g. Ar) is respectively controlled by a mass flow controller. The oxygen, Ar, the gas evaporated from the aqueous methanol and steam are charged into a mixing chamber and mixed homogeneously to obtain a mixture. The mixture (reactant 300) is then fed to a catalyst bed 200 in the thermally-insulated reactor 100 to generate product 400, hydrogen and carbon dioxide. An oxygen/methanol molar ratio of the gas mixture is between about 0 and 0.7, and a water/methanol molar ratio of the gas mixture is between about 0.7 and 2.5. The oxygen may be provided with air or pure oxygen. The product 400 is then subjected to a quantitative analysis carried out by a TCD (thermal conductivity detector) for a methanol conversion rate (C_{MeOH}) and CO selectivity (S_{CO}) to be calculated as follows:

C_{MeOH}=(n_{MeOH,in}−n_{MeOH,out})/n_{MeOH,in}×100%

S_{CO}=n_{CO}/(n_{CO2}+n_{CO})×100%

As for the composition ratio of the AuCu/ZnO catalyst, the Cu content in the AuCu/ZnO-based catalyst is substantially between 20% and 50% (w/w). The Au content in the AuCu/ZnO-based catalyst is substantially between 0.1% and 10% (w/w), preferably between 1% and 5% (w/w), and the particle size of the Au particle in the AuCu/ZnO-based catalyst is not greater than 10.0 nm. In addition, the catalyst provided by the present invention may catalyze the hydrogen production process without undergoing a pre-reduction step. The gas mixture is then catalyzed by the AuCu/ZnO for OSRM process at its initiation temperature less than 175° C., preferably less than 155° C. The AuCu/ZnO— catalyzed OSRM process may have low S_{CO} (≦2%) and each mole of consumed methanol may generate more than 2 moles of hydrogen gas.

Referring to table 1, where the oxygen/methanol molar ratio is 0.25 and the water/methanol molar ratio is 1.0, the non-reduced Cu/ZnO catalyst has an initiation temperature at 195° C., and the reduced Cu/ZnO may lower the initiation temperature to 185° C. In comparison to Cu/ZnO catalysts, the non-reduced AuCu/ZnO catalysts have lower initiation temperatures (Tᵢ) (<175° C., where the Tᵢ for Au_{0.8}Cu₃₀/ZnO is 170° C.; the Tᵢ for Au₃Cu₃₀/ZnO is 155° C.; the Tᵢ for Au_{4.3}Cu₃₀/ZnO is 145° C.). On the other hand, the Tᵢ for Au_{2.4}/ZnO is 80° C.

TABLE 1
The OSRM initiation temperatures of Catalysts (Oxygen/methanol
molar ratio is 0.25, and water/methanol molar ratio is 1)

| NO. | Catalyst | Tᵢ (° C.) |
|---|---|---|
| 1 | Cu₃₀/ZnO | 195 |
| 2 | Cu₃₀/ZnO-pre-red | 185 |
| 3 | Au_{0.8}Cu₃₀/ZnO | 170 |
| 4 | Au₃Cu₃₀/ZnO | 155 |
| 5 | Au_{4.3}Cu₃₀/ZnO | 145 |
| 6 | Au_{2.4}/ZnO | 80 |

Referring to table 2, under the fixed reaction condition where oxygen/methanol molar ratio is 0.25, water/methanol molar ratio is 1, and T_{R} (reaction temperature) is 250° C., the Au/ZnO catalyst has the poorest catalytic efficiency (C_{MeOH}=41.7%, hydrogen production rate=64.9 mmols⁻¹ kg⁻¹, and S_{CO}=6.6%). The Au₃Cu₃₀/ZnO catalyst without undergoing pre-reduction has the highest catalytic efficiency (C_{MeOH}=96.3%, hydrogen production rate=220.6 mmols⁻¹ kg⁻¹, and S_{CO}=1.4%). Therefore, the AuCu/ZnO catalysts of the present invention have substantially the same catalytic efficiency as the Cu/ZnO catalysts and may lower the initiation temperature without greatly lowering catalytic activity.

TABLE 2
Catalytic efficiency of Catalysts in OSRM (T_{R} = 250° C.)

| | | | H₂ production | Sco |
|---|---|---|---|---|
| No. | catalyst | C_{MeOH}(%) | rate(mmols⁻¹kg⁻¹) | (%) |
| 1 | Cu₃₀/ZnO | 97.2 | 217.2 | 1.4 |
| 2 | Cu₃₀/ZnO-pre-red | 97.9 | 215.1 | 2.2 |
| 3 | Au_{0.8}Cu₃₀/ZnO | 97.3 | 215.2 | 1.4 |
| 4 | Au₃Cu₃₀/ZnO | 96.3 | 220.6 | 1.4 |
| 5 | Au_{4.3}Cu₃₀/ZnO | 97.1 | 219.4 | 1.1 |
| 6 | Au_{2.4}/ZnO | 41.7 | 64.9 | 6.6 |

Therefore, the AuCu/ZnO catalysts of the present invention lower the Tᵢ (<175° C.) of OSRM process and remain to have good catalytic efficiency without undergoing a pre-reduction step. When used for the OSRM process, the AuCu/ZnO catalysts may decrease initiation time, energy loss and cost and have enhanced stability and life expectancy.

Also, in one embodiment, one catalyst having lower Tᵢ and the other catalyst having higher catalytic efficiency may be applied simultaneously in OSRM process. Due to the nature of an exothermal reaction, the OSRM may be ignited by the catalyst having lower Tᵢ. Once ignited, the reaction is propagated for the other catalyst having higher catalytic efficiency to catalyze hydrogen production.

SRM process: CH₃OH_{(g)}+H₂O_{(g)}→3H₂+CO₂

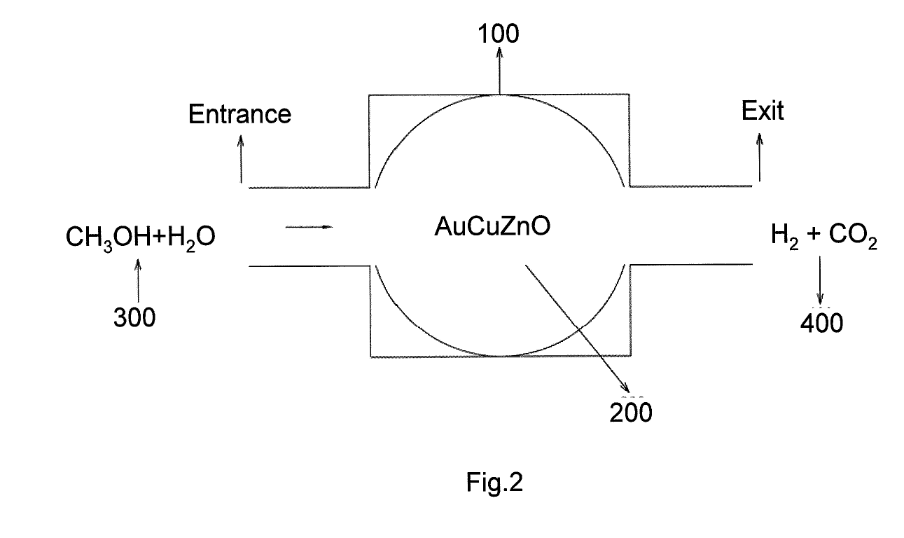

FIG. 2 is a schematic diagram illustrating a SRM system for hydrogen production according to one embodiment of the present invention. In a fixed bed reactor or a thermally-insulated reactor 100, a 100 mg AuCu/ZnO catalyst sample is placed in a quartz tube with 4 mm inner diameter and is immobilized with silica wool. The gas mixture (reactant 300) containing aqueous methanol and steam is then fed to a catalyst bed 200 in the thermally-insulated reactor 100 to generate product 400. A water/methanol molar ratio of the gas mixture is between about 0.7 and 2.5. The AuCu/ZnO-catalyzed SRM process may have low S_{CO} (≦2%) and each mole of consumed methanol may generate more than 2.2 moles of hydrogen gas. The composition and property of the AuCu/ZnO catalyst have been described and thus omitted here.

Under the fixed reaction condition where water/methanol molar ratio is 1, the air flow rate is 100 mL/min, the amount of catalyst is 100 mg and T_{R} (reaction temperature) is 300° C., it is found that it takes higher reaction temperature for the SRM process to achieve a higher conversion rate compared to OSRM process. Under the fixed reaction condition for SRM process where water/methanol molar ratio is 1, and T_{R} (reaction temperature) is 300° C., the AuCu/ZnO catalyst has better catalytic efficiency (C_{MeOH}=99.5%, hydrogen production rate=251.6 mmols⁻¹ kg⁻¹, and S_{CO}=4.5% for Au_{4.3}Cu₃₀/ZnO) in comparison to non-reduced Cu/ZnO catalyst. Particularly, for lower Au content in AuCu/ZnO catalysts, the S_{CO} of AuCu/ZnO catalysts is lower than the pre-reduced Cu/ZnO catalyst (S_{CO}=2.2% for Au_{0.8}Cu₃₀/Zn and S_{CO}=3.6% for Au₃Cu₃₀/ZnO); for higher Au content in AuCu/ZnO catalysts, the C_{MeOH} of AuCu/ZnO catalysts is higher than the pre-reduced Cu/ZnO catalyst (C_{MeOH}=99.5% for Au_{4.3}Cu₃₀/ZnO).

TABLE 3
Catalytic efficiency of Catalysts in OSRM (water/methanol
molar ratio is 1, T_{R} = 300° C.)

| | | | H₂ rate | Sco |
|---|---|---|---|---|
| No. | catalysts | C_{MeOH}(%) | (mmols⁻¹kg⁻¹) | (%) |
| 1 | Cu₃₀/ZnO | 97.6 | 247.6 | 4.4 |
| 2 | Cu₃₀/ZnO-pre-red | 99.1 | 257.6 | 5.8 |
| 3 | Au_{0.8}Cu₃₀/ZnO | 96.4 | 245.3 | 2.2 |
| 4 | Au₃Cu₃₀/ZnO | 97.6 | 247.1 | 3.6 |
| 5 | Au_{4.3}Cu₃₀/ZnO | 99.5 | 251.6 | 4.5 |
| 6 | Au_{2.4}/ZnO | 15.5 | 36.9 | 19.5 |

The present invention may cause some impacts on the development of petroleum industry, fuel cell technology, and hydrogen economy since PEMFCs (Proton Exchange Membrane Fuel Cell) have now been regarded as a power source with high potential for notebook computers, mobile phones and digital cameras. The OSRM process at low temperature catalyzed by AuCu/ZnO catalysts of this present invention is of high hydrogen yield and may be applied to PEMFC.

To sum up, the AuCu/ZnO catalysts of the present invention may lower the initiation temperature of OSRM process and remains to have good catalytic efficiency in OSRM process and SRM process without undergoing a pre-reduction step, and may increase system simplicity for commercialization.

While the invention can be subject to various modifications and alternative forms, a specific example thereof has been shown in the drawings and is herein described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. An oxidative steam reforming of methanol process at low temperature, comprising:
providing a gas mixture comprising methanol, steam and oxygen; and
conducting the gas mixture to flow through an AuCu/ZnO-based catalyst for undergoing OSRM process to generate hydrogen, wherein an initiation temperature of OSRM is less than 175° C.

2. The OSRM process as claimed in claim 1, wherein an initiation temperature of the gas mixture is less than 155° C.

3. The OSRM process as claimed in claim 1, wherein the S_{CO} of the hydrogen is not greater than 2%, and each mole of consumed methanol generates more than 2 moles of hydrogen gas.

4. The OSRM process as claimed in claim 1, wherein an oxygen/methanol molar ratio of the gas mixture is between 0 and 0.7, and a water/methanol molar ratio of the gas mixture is between 0.7 and 2.5.

5. The OSRM process as claimed in claim 1, wherein the Cu content in the AuCu/ZnO-based catalyst is substantially between 20% and 50% (w/w).

6. The OSRM process as claimed in claim 1, wherein the Au content in the AuCu/ZnO-based catalyst is substantially between 0.1% and 10% (w/w).

7. The OSRM process as claimed in claim 1, wherein the Au content in the AuCu/ZnO-based catalyst is substantially between 1% and 5% (w/w).

8. The OSRM process as claimed in claim 1, wherein the particle size of the Au particle in the AuCu/ZnO-based catalyst is not greater than 10.0 nm.

9. The OSRM process as claimed in claim 1, wherein the OSRM process is catalyzed by the AuCu/ZnO-based catalyst without undergoing a pre-reduction step.

10. A steam reforming of methanol process at low temperature, comprising:
providing a gas mixture comprising methanol and steam; and
conducting the gas mixture to flow through an AuCu/ZnO-based catalyst for undergoing SRM process to generate hydrogen.

11. The SRM process as claimed in claim 10, wherein the S_{CO} of the hydrogen is not greater than 5%, and each mole of consumed methanol generates more than 2.2 moles of hydrogen gas.

12. The SRM process as claimed in claim 10, wherein a water/methanol molar ratio of the gas mixture is between 0.7 and 2.5.

13. The SRM process as claimed in claim 10, wherein the Cu content in the AuCu/ZnO-based catalyst is substantially between 20% and 50% (w/w).

14. The SRM process as claimed in claim 10, wherein the Au content in the AuCu/ZnO-based catalyst is substantially between 0.1% and 10% (w/w).

15. The SRM process as claimed in claim 10, wherein the Au content in the AuCu/ZnO-based catalyst is substantially between 1% and 5% (w/w).

16. The SRM process as claimed in claim 10, wherein the particle size of the Au particle in the AuCu/ZnO-based catalyst is not greater than 10.0 nm.

17. The SRM process as claimed in claim 10, wherein the SRM process is catalyzed by the AuCu/ZnO-based catalyst without undergoing a pre-reduction step.
